(19) United States
(12) Patent Application Publication
(10) Pub. No.: US 2026/0071985 A1
(43) Pub. Date: Mar. 12, 2026

(54) TEMPERATURE AND HUMIDITY MEASURING DEVICE AND WET BULB SUPPLY MODULE

(71) Applicant: RADIANT INNOVATION INC., Hsinchu County (TW)

(72) Inventors: YUNG-CHANG CHANG, Hsinchu County (TW); SHIH-HONG LIN, Taichung City (TW)

(21) Appl. No.: 18/830,745

(22) Filed: Sep. 11, 2024

(51) Int. Cl. G01N 25/64; G01K 13/00

(52) U.S. Cl. CPC G01N 25/64; G01K 13/00

(57) ABSTRACT

A temperature and humidity measuring device and a wet bulb supply module are provided. The temperature and humidity measuring device includes a measuring module and the wet bulb supply module. The measuring module has a first and a second measuring portion for acquiring first and second temperature information, respectively. The wet bulb supply module includes a container component, a position limiting component, and a wet bulb component. The container component has a first opening, a second opening, and an accommodating space that is in spatial communication with the first and the second opening. The position limiting component has a gripping portion. The wet bulb supply module is configured to allow the measuring module to extend into the accommodating space through the second opening, is configured to use the gripping portion to grip the measuring module, and is configured cover the second measuring portion with the wet bulb component.

### FIELD OF THE DISCLOSURE

The present disclosure relates to a temperature and humidity measuring device and a wet bulb supply module, and more particularly to a temperature and humidity measuring device for measuring relative humidity and a wet bulb supply module for placement of humidity measuring tools.

### BACKGROUND OF THE DISCLOSURE

Relative humidity is a ratio of an actual moisture content in the atmosphere to a saturated moisture content at the same temperature and the same pressure. For example, at a fixed temperature, 100 moisture molecules can be accommodated in a defined space; while in reality, only 50 moisture molecules are present therein. As such, the “relative humidity” is 50%. Under this circumstance, since the relative humidity is only 50%, the atmosphere is considered to be relatively dry. For conventional humidity detectors, measurement bias is likely to occur due to long-term exposure to an environment having a high temperature and a high humidity. Therefore, using wet-and-dry-bulb thermometers for detecting the relative humidity is a more reliable method.

### SUMMARY OF THE DISCLOSURE

In response to the above-referenced technical inadequacy, the present disclosure provides a temperature and humidity measuring device and a wet bulb supply module. In the present disclosure, a conventional probe thermometer (e.g., a thermocouple thermometer) is used in cooperation with a wet bulb temperature supply module to achieve the function of humidity measurement. In a probe temperature mode, the function of measuring a temperature of a probe is maintained. In a humidity mode, relative humidity and a dew point can be measured and displayed through cooperation of a wet bulb device. In this way, a multi-functional temperature and humidity measuring device can be realized.

In order to solve the above-mentioned problem, one of the technical aspects adopted by the present disclosure is to provide a temperature and humidity measuring device, which includes a measuring module and a wet bulb supply module. The measuring module has a first measuring portion configured to measure a temperature of a current environment under a first state for acquiring first temperature information, and a second measuring portion configured to measure a temperature of a current environment under a second state for acquiring second temperature information. The wet bulb supply module includes a container component, a position limiting component, and a wet bulb component. The container component has a first opening formed on a top surface of the container component, a second opening formed on a side surface of the container component, and an accommodating space in spatial communication with the first opening and the second opening, and the accommodating space is configured to accommodate a liquid. The position limiting component is disposed in the accommodating space, and has at least one gripping portion that corresponds to the second opening. The wet bulb component is disposed in the accommodating space, and corresponds to the first opening. The wet bulb component is configured to contact the liquid. The wet bulb supply module is configured to allow the measuring module to extend into the accommodating space through the second opening, and is configured to use the at least one gripping portion to grip the measuring module, and is configured to cover the second measuring portion with the wet bulb component, so that the second measuring portion is in the second state.

In one of the possible or preferred embodiments, the measuring module includes a body component, a first measuring component, a second measuring component, and a processing component. The first measuring component is disposed in the body component, and one end of the first measuring component has the first measuring portion. The second measuring component is connected to the body component, and one end of the second measuring component has the second measuring portion. The processing component is disposed in the body component, and is connected to the first measuring component and the second measuring component. The processing component is configured to receive the first temperature information and the second temperature information, and is configured to acquire relative humidity information according to a first equation. The first equation is:

$$RH = \frac{{e}_{w} - N * ( 1 + 0.00115 * {T}_{w} ) * ( {T}_{d} - {T}_{w} )}{{e}_{d}} * 100 .$$

In the first equation, RH is the relative humidity information, e_{d} is a dry vapor pressure parameter, e_{w} is a wet vapor pressure parameter, N is taken as 0.6687451584, T_{d} is the first temperature information, and T_{w} is the second temperature information. The processing component is configured to acquire the dry vapor pressure parameter according to the first temperature information and a second equation, and is configured to acquire the dry vapor pressure parameter according to the second temperature information and a third equation. The second equation is:

$${e}_{d} = 6.112 * {e}^{( \frac{17.502 * {T}_{d}}{240.97 + {T}_{d}} )} .$$

The third equation is:

$${e}_{w} = 6.112 * {e}^{( \frac{17.502 * {T}_{w}}{240.97 + {T}_{w}} )} .$$

In the second equation and the third equation, e is taken as 2.71828182845904.

In one of the possible or preferred embodiments, the processing component is configured to acquire a first algebra parameter according to the relative humidity information and a fourth equation. The first algebra parameter is L, and the fourth equation is: L=ln(RH/100). The processing component is configured to acquire a second algebra parameter according to the first temperature information and a fifth equation. The second algebra parameter is M, and the fifth equation is: M=17.27*T_{d}. The processing component is configured to acquire a third algebra parameter according to the first temperature information and a sixth equation. The third algebra parameter is N, and the sixth equation is: N=237.3+Ta. The processing component is configured to acquire a fourth algebra parameter according to the first algebra parameter, the second algebra parameter, the third algebra parameter, and a seventh equation. The fourth algebra parameter is B, and the seventh equation is: B=(L+(M/N))/17.27. The processing component is configured to acquire dew point information according to the fourth algebra parameter and a eighth equation. The dew point information is T_{dew}, and the eighth equation is: T_{dew}=(237.3*B)/(1−B).

In one of the possible or preferred embodiments, the container component includes a main body member which has a top portion, a bottom portion disposed opposite to the top portion, and a plurality of side portions. The top portion has the first opening, and the side portions are connected to the top portion and the bottom portion to define the accommodating space, and one of the side portions has the second opening. The position limiting component includes a first fastener, a second fastener, and at least one positioning member, and the first fastener and the second fastener are connected to the top portion or one or more side portions. The at least one positioning member is connected to the first fastener and the second fastener, and is disposed between the first fastener and the second fastener. One side of the at least one positioning member is recessed to form the at least one gripping portion, and the at least one gripping portion has a notch that corresponds to the top portion or the bottom portion.

In one of the possible or preferred embodiments, the container component further includes a first cover body and a second cover body, the first cover body is movably connected to the main body member and opens or covers the first opening, and the second cover body is movably connected to the main body member and opens or covers the second opening.

In one of the possible or preferred embodiments, the container component includes a main body member which has a top portion, a bottom portion disposed opposite to the top portion, and a plurality of side portions. The top portion has the first opening, and the side portions are connected to the top portion and the bottom portion to define the accommodating space, and one of the side portions has the second opening. The position limiting component includes a base member and at least one positioning member, and the base member is connected to the bottom portion, and the at least one positioning member is connected to the base member. One side of the at least one positioning member is recessed to form the at least one gripping portion which has a notch, and the notch corresponds to the top portion.

In order to solve the above-mentioned problem, another one of the technical aspects adopted by the present disclosure is to provide a wet bulb supply module, which includes a container component, a position limiting component, and a wet bulb component. The container component has a first opening formed on a top surface of the container component, and the second opening is formed on a side surface of the container component. The accommodating space is in spatial communication with the first opening and the second opening, and is configured to accommodate a liquid. The position limiting component is disposed in the accommodating space, and has at least one gripping portion which corresponds to the second opening. The wet bulb component is positioned in the accommodating space, and corresponds to the first opening. The wet bulb component is configured to contact the liquid. The wet bulb supply module is configured to allow the measuring module to extend into the accommodating space through the second opening, and is configured to use the at least one gripping portion to grip the measuring module, and is configured to cover the measuring module with the wet bulb component.

In one of the possible or preferred embodiments, the container component includes a main body member with a top portion, a bottom portion disposed opposite to the top portion, and a plurality of side portions. The top portion has the first opening, and the side portions are connected to the top portion and the bottom portion to define the accommodating space. One of the side portions has the second opening. The position limiting component includes a first fastener, a second fastener connected to the top portion or at least one side portion, and at least one positioning member connected to the first fastener and the second fastener and positioned between the first fastener and the second fastener. One side of the at least one positioning member is recessed to form the at least one gripping portion, and the at least one gripping portion has a notch that corresponds to the top portion or the bottom portion.

In one of the possible or preferred embodiments, the container component further includes a first cover body and a second cover body, and the first cover body is movably connected to the main body member, and is configured to open or cover the first opening, and the second cover body is movably connected to the main body member, and is configured to open or cover the second opening.

In one of the possible or preferred embodiments, the container component includes a main body member, and the main body member has a top portion, a bottom portion disposed opposite to the top portion, and a plurality of side portions. The top portion has the first opening, and the side portions are connected to the top portion and the bottom portion to define the accommodating space. One side portion has the second opening. The position limiting component includes a base member and at least one positioning member, and the base member is connected to the bottom portion and the at least one positioning member is connected to the base member. One side of the at least one positioning member is recessed to form the at least one gripping portion, and the at least one gripping portion has a notch that corresponds to the top portion.

Therefore, in the temperature and humidity measuring device provided by the present disclosure, by virtue of “the measuring module having a first measuring portion and a second measuring portion, the first measuring portion being configured to measure a temperature of a current environment under a first state for acquiring first temperature information, and the second measuring portion being configured to measure the temperature of the current environment under a second state for acquiring second temperature information,” “the wet bulb supply module including a container component, a position limiting component, and a wet bulb component, the container component having a first opening, a second opening, and an accommodating space, the first opening being formed on a top surface of the container component, the second opening being formed on a side surface of the container component, the accommodating space being in spatial communication with the first opening and the second opening, and the accommodating space being configured to accommodate a liquid,” “the position limiting component being disposed in the accommodating space and having at least one gripping portion that corresponds to the second opening,” “the wet bulb component being disposed in the accommodating space and corresponding to the first opening, and the wet bulb component being configured to contact the liquid,” and “the wet bulb supply module being configured to allow the measuring module to extend into the accommodating space through the second opening, being configured to use the at least one gripping portion to grip the measuring module, and being configured to cover the second measuring portion with the wet bulb component, so that the second measuring portion is in the second state,” the convenience in measuring the relative humidity can be improved.

Moreover, in the wet bulb supply module provided by the present disclosure, by virtue of “the container component having a first opening, a second opening, and an accommodating space, the first opening being formed on a top surface of the container component, the second opening being formed on a side surface of the container component, the accommodating space being in spatial communication with the first opening and the second opening, and the accommodating space being configured to accommodate a liquid,” “the position limiting component being disposed in the accommodating space and having at least one gripping portion that corresponds to the second opening,” “the wet bulb component being disposed in the accommodating space and corresponding to the first opening, and the wet bulb component being configured to contact the liquid,” and “the wet bulb supply module being configured to allow a measuring module to extend into the accommodating space through the second opening, being configured to use the at least one gripping portion to grip the measuring module, and being configured to cover the measuring module with the wet bulb component,” the convenience in measuring the relative humidity can be improved.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic perspective view of a measuring module according to a first embodiment of the present disclosure;

FIG. 2 is another schematic perspective view of the measuring module according to the first embodiment of the present disclosure;

FIG. 3 is a functional block diagram of the measuring module according to the first embodiment of the present disclosure;

FIG. 4 is a schematic perspective view of a wet bulb supply module according to the first embodiment of the present disclosure;

FIG. 5 is a schematic view of the wet bulb supply module in use according to the first embodiment of the present disclosure;

FIG. 6 is a schematic view of a temperature and humidity measuring device in use according to the first embodiment of the present disclosure;

FIG. 7 is a schematic view of one configuration of the wet bulb supply module according to the first embodiment of the present disclosure;

FIG. 8 is a schematic view of another configuration of the wet bulb supply module according to the first embodiment of the present disclosure;

FIG. 9 is a schematic side view of a wet bulb supply module according to a second embodiment of the present disclosure; and

FIG. 10 is a schematic cross-sectional view of the wet bulb supply module according to the second embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

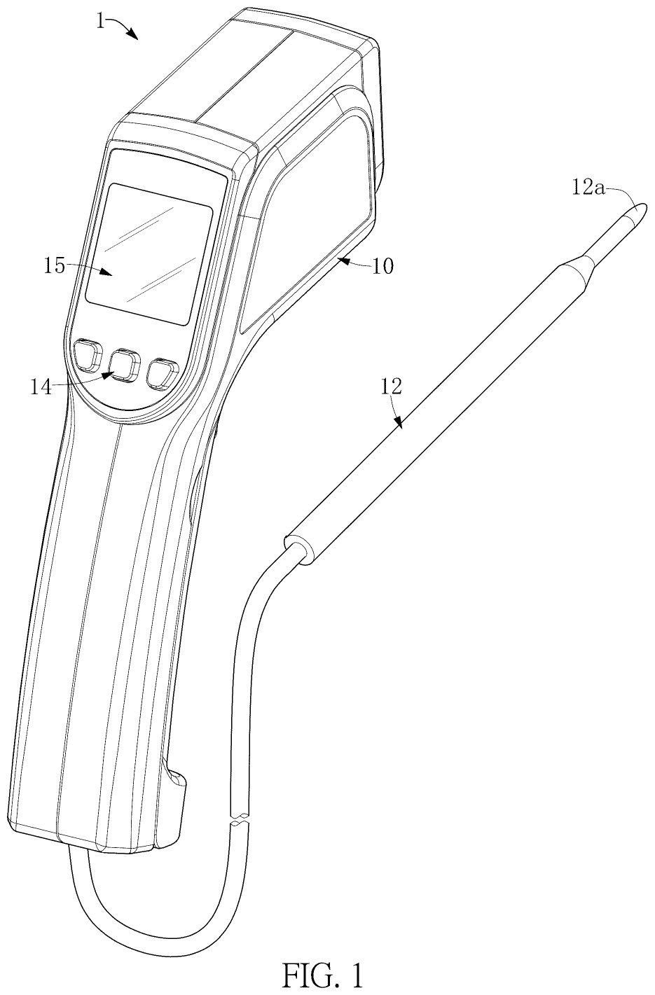

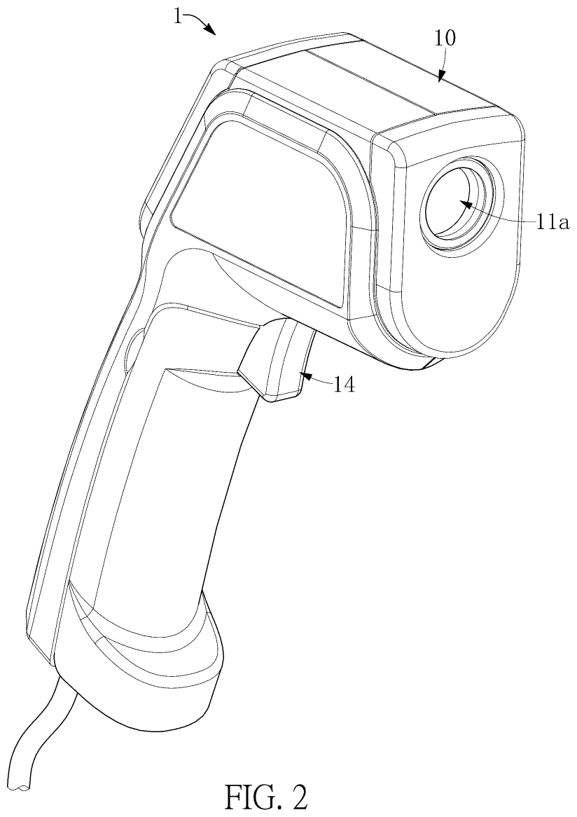

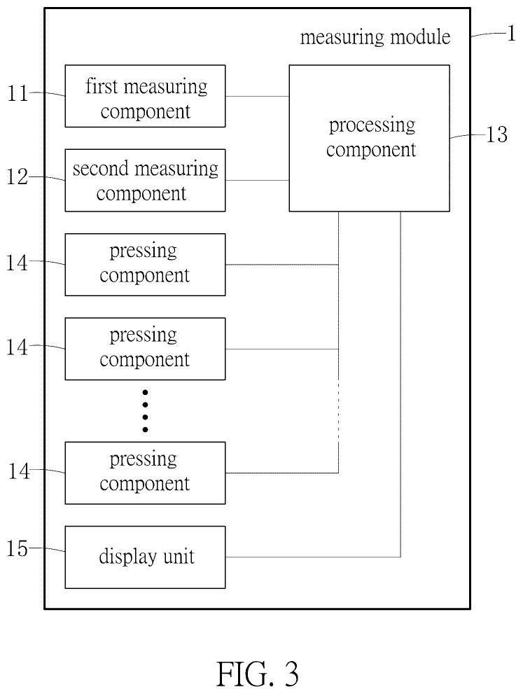

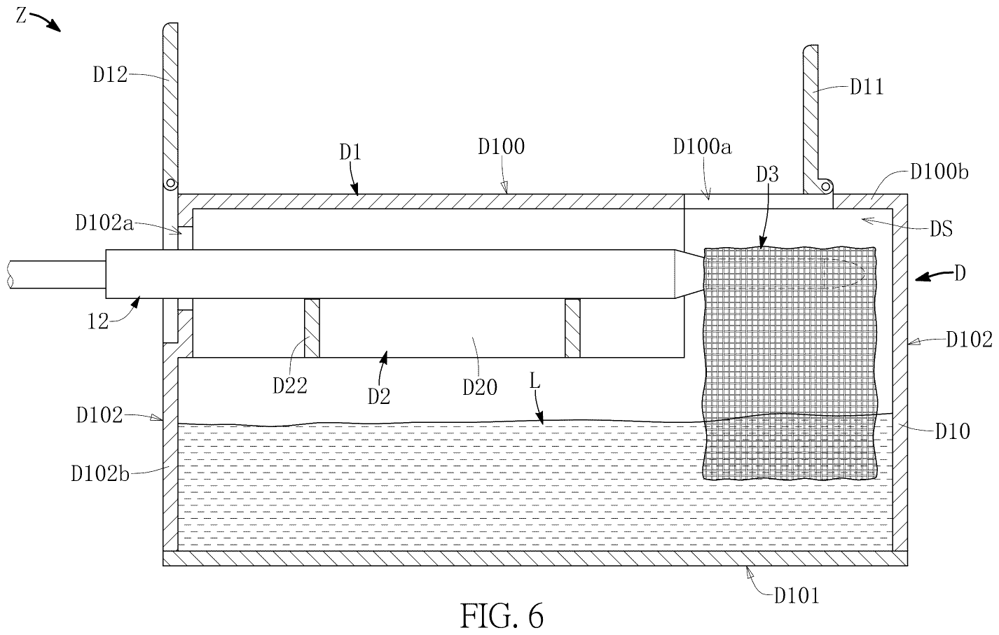

Reference is made to FIG. 1 to FIG. 8, which are respectively a schematic perspective view of a measuring module, another schematic perspective view of the measuring module, a functional block diagram of the measuring module, a schematic perspective view of a wet bulb supply module, a schematic view of the wet bulb supply module in use, a schematic view of a temperature and humidity measuring device in use, a schematic view of one configuration of the wet bulb supply module, and a schematic view of another configuration of the wet bulb supply module according to a first embodiment of the present disclosure. As illustrated in the above figures, the first embodiment of the present disclosure provides a temperature and humidity measuring device Z, which includes a measuring module 1 and a wet bulb supply module D.

As shown in FIG. 1 to FIG. 3, the measuring module 1 of the present disclosure has a first measuring portion 11a configured to measure a temperature of a current environment under a first state to obtain first temperature information, and a second measuring portion 12a configured to measure a temperature of the current environment under a second state to obtain second temperature information.

For example, the measuring module 1 includes a body component 10, a first measuring component 11, a second measuring component 12, and a processing component 13. The body component 10 can be a casing structure. The first measuring component 11 can be an infrared temperature sensor or a sensing component of other types, and the first measuring component 11 can be used for sensing the temperature of the current environment, so as to obtain the first temperature information (such as a room temperature). The first measuring component 11 can be disposed on the body component 10, and one end of the first measuring component 11 has the first measuring portion 11a. The second measuring component 12 can be a conventional probe thermometer (such as a thermocouple thermometer) or a sensing component of other types, and can be used for sensing a temperature of an object, so as to obtain the second temperature information (such as an object temperature). The second measuring component 12 can be connected to the body component 10 in a wired manner (such as a cable), and one end of the second measuring component 12 has the second measuring portion 12a. The processing component 13 can be a circuit board or a module component having the function of processing, controlling, memorizing, etc. The processing component 13 can be positioned in the body component 10, and is electrically connected to the first measuring component 11 and the second measuring component 12. In particular, the measuring module 1 of the present disclosure further includes a plurality of pressing components 14 and a display unit 15. The pressing components 14 can be disposed on the body component 10, and can be physical buttons or virtual buttons. The pressing components 14 are connected to the processing component 13. The display unit 15 can be a display screen. The display unit 15 can be disposed on the body component 10, and is connected to the processing component 13. The pressing components 14 can also be combined with the display unit 15 to form a touch screen module.

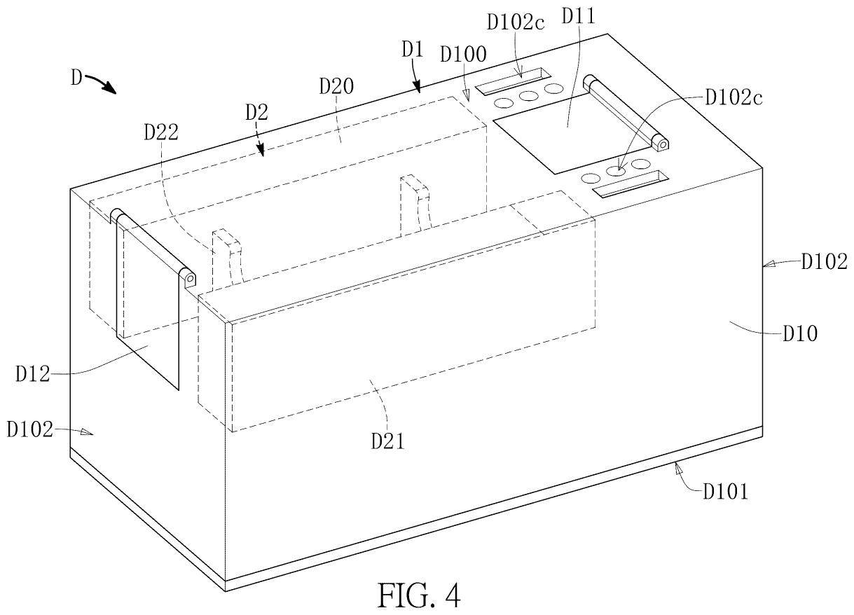

As shown in FIG. 4 to FIG. 8, the wet bulb supply module D of the present disclosure includes a container component D1, a position limiting component D2, and a wet bulb component D3. The container component D1 can have a first opening D100a, a second opening D102a, and an accommodating space DS. The first opening D100a can be formed on a top surface D100b of the container component D1, and the second opening D102a can be formed on a side surface D102b of the container component D1. The accommodating space DS is configured to communicate the first opening D100a and the second opening D102a, and is configured to accommodate a liquid L. The position limiting component D2 can be disposed in the accommodating space DS, and can have at least one gripping portion D22a that corresponds to the second opening D102a. The wet bulb component D3 can be disposed in the accommodating space DS and correspond to the first opening D100a. The wet bulb component D3 can be configured to contact the liquid L.

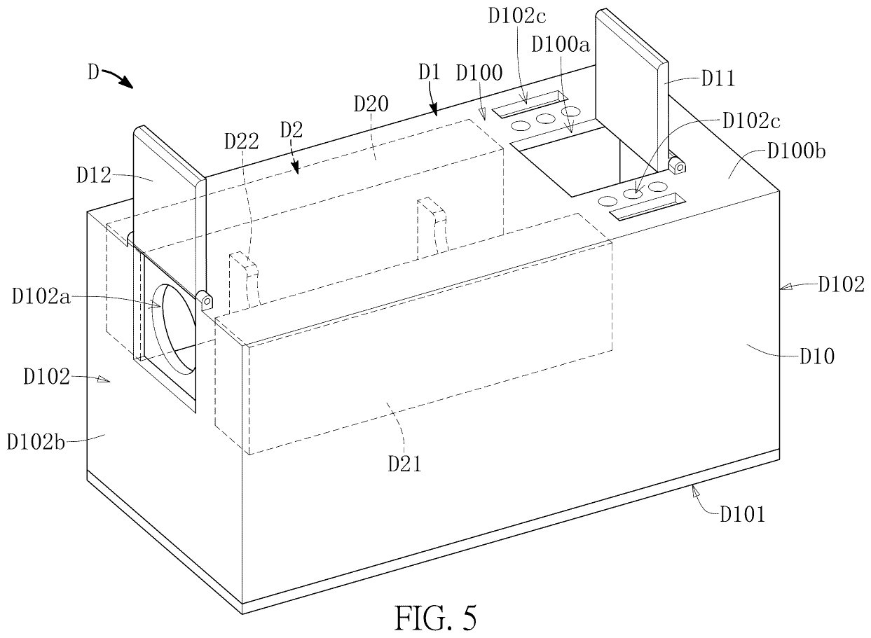

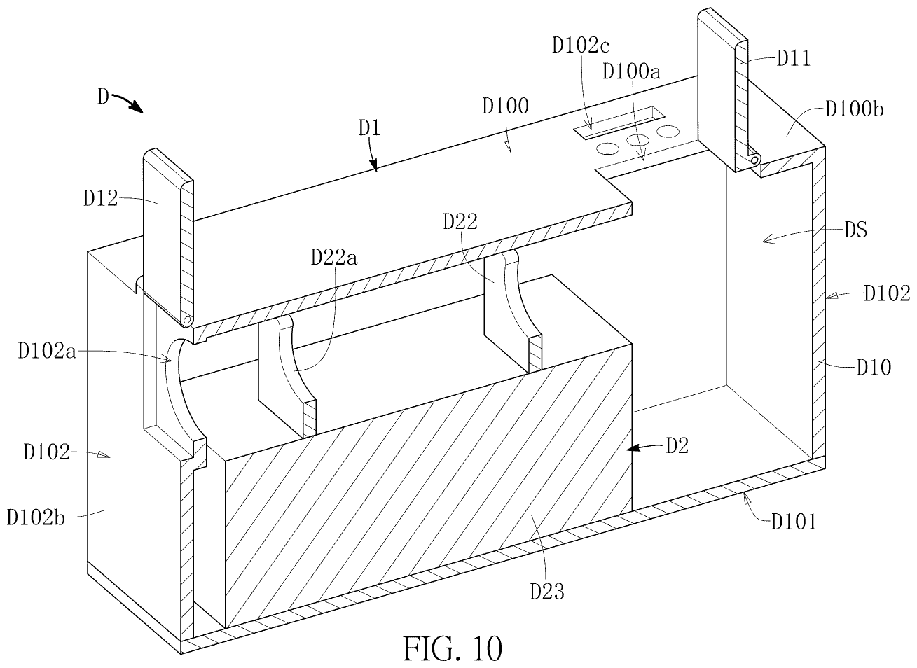

The container component D1 can be a casing structure having a geometrical shape, and is exemplified to have a square shape in the present embodiment (but is not limited thereto). Specifically, the container component D1 includes a main body member D10, and the main body member D10 has a top portion D100, a bottom portion D101, and a plurality of side portions D102. The top portion D100 has the first opening D100a and the top surface D100b. The bottom portion D101 is disposed opposite to the top portion D100. The side portions D102 can be connected to the top portion D100 and the bottom portion D101 to define the accommodating space DS, and one of the side portions D102 can have the second opening D102a. Each side portion D102 can have the side surface D102b. The first opening D100a is adjacent to one end of the container component D1, and the second opening D102a is disposed at the other end of the container component D1. Also, for the purpose of the air circulation between the accommodating space DS and the environment outside the container component D1, a plurality of vents D102c can be arranged on the top portion D100. Although in FIG. 4, FIG. 5, and FIG. 10, the vents D102c are shown to have circular or long shape, other geometrical shapes are also possible. The number and positions of the vents D102c are not specifically limited, either, as along as sufficient air circulation can be achieved.

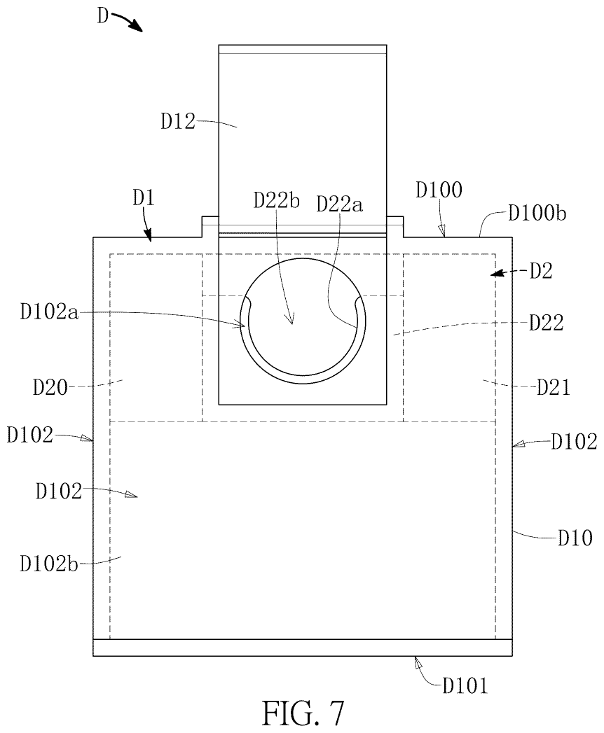

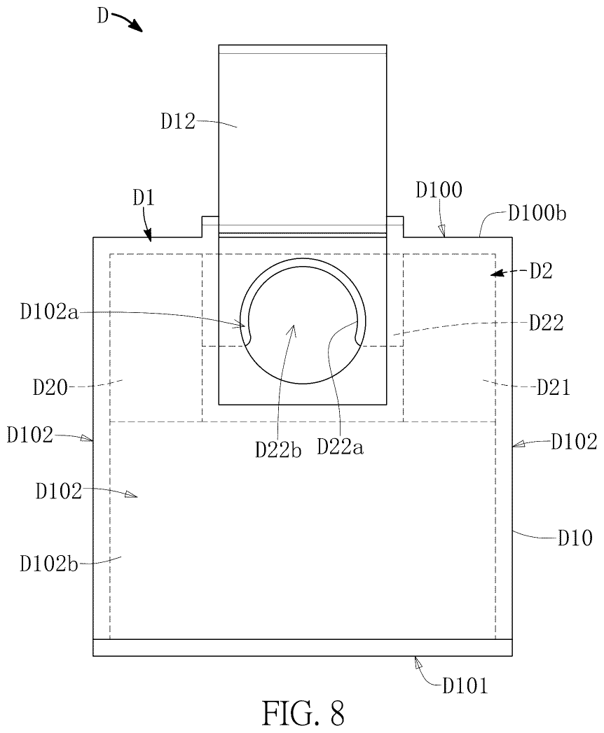

Moreover, the position limiting component D2 can include a first fastener D20, a second fastener D21, and at least one positioning member D22. The first fastener D20 can be connected to the top portion D100 or one or more of the side portions D102. The second fastener D21 can be connected to the top portion D100 or one or more of the side portions D102. The first fastener D20 and the second fastener D21 can be disposed opposite to each other, and the first fastener D20 and the second fastener D21 can each be an elongated member (but are not limited thereto). One end of the positioning member D22 can be connected to the first fastener D20, and the other end of the positioning member D22 can be connected to the second fastener D21. The positioning member D22 can be positioned between the first fastener D20 and the second fastener D21. One side of the position limiting component D2 can be recessed to form the gripping portion D22a, and the gripping portion D22a can have a notch D22b that corresponds to the top portion D100 (as shown in FIG. 5 and FIG. 7) or the bottom portion D101 (as shown in FIG. 8). In the present embodiment, the quantity of the position limiting component D2 is exemplified as being two, but is not limited thereto.

Therefore, the wet bulb supply module D of the present disclosure is configured to allow the measuring module 1 to extend into the accommodating space DS through the second opening 102a, and is configured to use the at least one gripping portion D22a to grip the measuring module 1, and is configured to cover the second measuring portion 12a with the wet bulb component D3, so that the second measuring portion 12a is in the second state. Also, when the wet bulb component D3 is to be cooled down, the required evaporation and ventilation between the accommodating space DS and the environment outside the container component D1 can be realized through the vents D102c on the top portion D100.

For example, as shown in FIG. 1 to FIG. 8, when the temperature and humidity measuring device Z of the present disclosure is put to actual use by a user, the user can insert the second measuring component 12 of the measuring module 1 into the second opening D102a of the wet bulb supply module D, such that the second measuring portion 12a of the second measuring component 12 is adjacent to the first opening D100a. At this time, the second measuring component 12 is gripped and positioned in the container component D1 by the gripping portions D22a of the position limiting components D2. In addition, the user can cover the second measuring portion 12a of the second measuring component 12 with the wet bulb component D3, and make a portion of the wet bulb component D3 contact the liquid L (such as water, but is not limited thereto) in the container component D1.

Then, the user can operate the measuring module 1. By pressing the at least one pressing component 14, the processing component 13 is triggered to control the first measuring component 11 and the second measuring component 12 to perform a sensing operation. That is, the processing component 13 can control the first measuring component 11 to use the first measuring portion 11a for measuring the temperature of the current environment under the first state (such as not being shielded or covered by any object), so as to acquire the first temperature information (such as a dry bulb temperature). Moreover, the processing component 13 can control the second measuring portion 12a to use the second measuring portion 12a for measuring the temperature of the current environment under the second state (such as being shielded or covered by an object), so as to acquire the second temperature information (such as a wet bulb temperature).

Next, the processing component 13 can receive the first temperature information and the second temperature information, and calculate and acquire relative humidity information (such as relative humidity of the current environment) according to a built-in or stored first equation. The first equation is:

$$RH = \frac{{e}_{w} - N * ( 1 + 0.00115 * {T}_{w} ) * ( {T}_{d} - {T}_{w} )}{{e}_{d}} * 100 .$$

In the above-mentioned first equation, RH can be the relative humidity information, e_{d} can be a dry vapor pressure parameter, e_{w} can be a wet vapor pressure parameter, N can be taken as 0.6687451584, T_{d} can be the first temperature information, and T_{w} can be the second temperature information.

Specifically, according to the first temperature information and second temperature information, the processing component 13 can acquire the above-mentioned dry vapor pressure parameter (i.e., e_{d}) and wet vapor pressure parameter (i.e., e_{w}) with a second equation and a third equation that are built-in or stored. That is, the dry vapor pressure parameter can be calculated and acquired by substituting the first temperature information into the second equation, and the wet vapor pressure parameter can be calculated and acquired by substituting the second temperature information into the third equation. The second equation is:

$${e}_{d} = 6.1 \; 12 * {e}^{( \frac{17.502 * {T}_{d}}{240.97 + {T}_{d}} )} .$$

The third equation is:

$${e}_{w} = 6.112 * {e}^{( \frac{17.502 * {T}_{w}}{240.97 + {T}_{w}} )} .$$

In the second equation and the third equation mentioned above, e can be taken as 2.71828182845904.

Specifically, according to the first temperature information and the relative humidity information, the processing component 13 can acquire dew point information with a fourth equation, a fifth equation, a sixth equation, a seventh equation, and an eighth equation that are built-in or stored. The processing component 13 can acquire a first algebra parameter according to the relative humidity information and the fourth equation, in which the first algebra parameter can be L, and the fourth equation can be: L=ln(RH/100). Next, the processing component 13 can acquire a second algebra parameter according to the first temperature information and the fifth equation, in which the second algebra parameter can be M, and the fifth equation can be: M=17.27*T_{d}. Then, the processing component 13 can acquire a third algebra parameter according to the first temperature information and the sixth equation, in which the third algebra parameter can be N, and the sixth equation can be: N=237.3+T_{d}. Subsequently, the processing component 13 can acquire a fourth algebra parameter according to the first algebra parameter, the second algebra parameter, the third algebra parameter, and the seventh equation, in which the fourth algebra parameter can be B, and the seventh equation can be: B=(L+ (M/N))/17.27. Finally, the processing component 13 can acquire the dew point information according to the fourth algebra parameter and the eighth equation, in which the dew point information can be T_{dew}, and the eighth equation can be: T_{dew}=(237.3*B)/(1−B).

The processing component 13 can control the display unit 15 to display relevant parameter information after acquiring at least one of the relative humidity information and the dew point information.

In addition, the measuring results of the temperature and humidity measuring device Z of the present disclosure and a Bosch® hygrometer in the same environment can be seen in Table 1 below.

TABLE 1

| | RH | T_{d} | T_{w} | | | | | T_{dew} | |
|---|---|---|---|---|---|---|---|---|---|
| Time | (%) | (° C.) | (° C.) | e_{d} | e_{w} | N | B | (° C.) | Bosch |
| 08:47 | 80.0 | 21.8 | 19.4 | 26.10848 | 22.51804 | 0.668745158 | 0.071190077 | 18.2 | 79 |
| 09:55 | 81.7 | 22 | 19.8 | 26.42913 | 23.08454 | 0.668745158 | 0.073106169 | 18.7 | 80 |
| 11:00 | 77.3 | 22.7 | 19.9 | 27.57872 | 23.2281 | 0.668745158 | 0.072383642 | 18.5 | 75 |
| 11:58 | 75.7 | 22.7 | 19.7 | 27.57872 | 22.94176 | 0.668745158 | 0.071223702 | 18.2 | 73 |
| 13:20 | 75.1 | 22.9 | 19.8 | 27.9151 | 23.08454 | 0.668745158 | 0.071428415 | 18.3 | 74 |
| 14:05 | 76.6 | 22.9 | 20 | 27.9151 | 23.37244 | 0.668745158 | 0.072588515 | 18.6 | 75 |
| 15:45 | 77.4 | 23 | 20.2 | 28.08464 | 23.66349 | 0.668745158 | 0.073552184 | 18.8 | 77 |
| 16:20 | 74.9 | 22.5 | 19.4 | 27.24588 | 22.51804 | 0.668745158 | 0.069845828 | 17.8 | 73 |
| 16:50 | 72.5 | 22.4 | 19 | 27.08079 | 21.96376 | 0.668745158 | 0.067652416 | 17.2 | 70 |

From the content of Table 1, it can be observed that the temperature and humidity measuring device Z of the present disclosure conducts nine measurements between 8:47 AM and 4:50 PM in the same day, and the acquired relative humidity information is 80%, 77.3%, 75.7%, 75.1%, 76.6%, 77.4%, 74.9%, and 72.5% in sequence. At the same time point, the relative humidity measured by the Bosch hygrometer is 79%, 80%, 75%, 73%, 74%, 75%, 77%, 73%, and 70 in sequence. Therefore, a difference value between the temperature and humidity measuring device Z of the present disclosure and the Bosch hygrometer is between 0.4% and 2.7%, and relative humidity values measured by the temperature and humidity measuring device Z of the present disclosure are very close to values measured by commercially available humidity sensors. That is, the temperature and humidity measuring device Z of the present disclosure has high accuracy and is reliable.

In general usage, the first measuring component 11 can be used to measure the temperature of the current environment, and the second measuring component 12 can be used to measure the temperature of an object. Based on the technical means described above, the temperature and humidity measuring device Z of the present disclosure enables the second measuring component 12 to measure and acquire the wet bulb temperature through implementation and the structural design of the wet bulb supply module D, and the relative humidity can be further obtained through cooperation with the dry bulb temperature acquired by the first measuring portion 11a. Therefore, the temperature and humidity measuring device Z of the present disclosure allows placement of the second measuring component 12, and provides convenience in acquiring the relative humidity. In addition, since the first equation to the eighth equation and the relevant parameters are stored in the processing component 13, the relative humidity, a dew point, or data thereof can be automatically calculated, thereby further improving the convenience in use.

Furthermore, the container component D1 of the present disclosure can further include a first cover body D11 which is movably connected to the main body member D10 and opens or covers the first opening D100a, and a second cover body D12 which is movably connected to the main body member D10 and opens or covers the second opening D102a.

For example, as shown in FIG. 4 to FIG. 6, the first cover body D11 and the second cover body D12 can be movably arranged on the container component D1, such as in a flip-cover or pull-out manner (but are not limited thereto). As such, when the container component D1 is not in the state of use, the first cover body D11 is configured to cover the first opening D100a, and the second cover body D12 is configured to cover the second opening D102a, so as to prevent leakage of the liquid L in the container component D1. When the user intends to use the container component D1, he/she can open the first opening D100a by moving the first cover body D11, and open the second opening D102a by moving the second cover body D102a.

According to the above content, as shown in FIG. 4 to FIG. 8, the present disclosure further provides a wet bulb supply module D, which includes a container component D1, a position limiting component D2, and a wet bulb component D3. The container component D1 can have a first opening D100a formed on a top surface of the container component D1, a second opening D102a formed on a side surface of the container component D1, and an accommodating space DS in spatial communication with the first opening D100a and the second opening D102a and for accommodating a liquid L. The position limiting component D2 can be disposed in the accommodating space DS, and have at least one gripping portion D22a that corresponds to the second opening D102a. The wet bulb component D3 can be positioned in the accommodating space DS, and can correspond to the first opening D100a. The wet bulb component D3 can be configured to contact the liquid L. The wet bulb supply module D can be configured to allow a measuring module 1 to extend into the accommodating space DS through the second opening D102a, and is configured to use the at least one gripping portion D22a to grip the measuring module 1, and is configured to cover the measuring module 1 with the wet bulb component D3.

However, the aforementioned examples describe only one of the embodiments of the present disclosure, and the present disclosure is not intended to be limited thereto.

### Second Embodiment

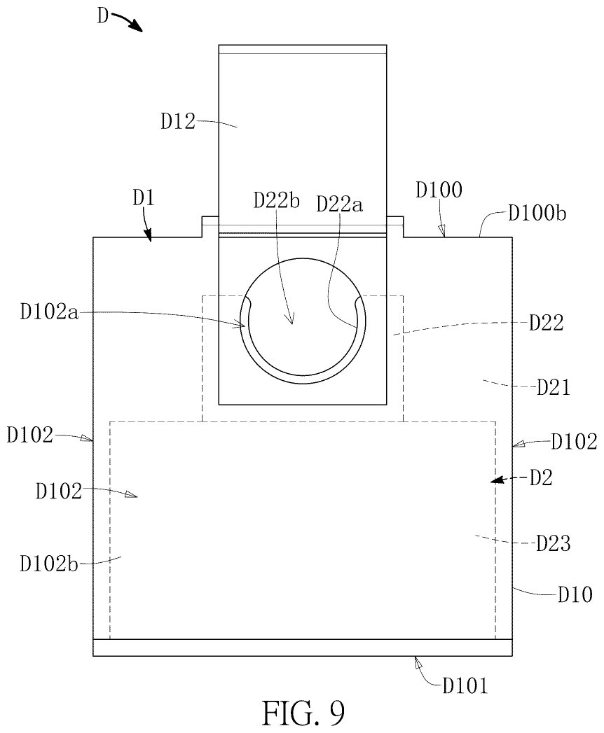

Referring to FIG. 9 and FIG. 10, which are to be read in conjunction with FIG. 1 to FIG. 8, FIG. 9 and FIG. 10 are respectively a schematic side view and a schematic cross-sectional view of a wet bulb supply module according to a second embodiment of the present disclosure. As shown in the figures, the temperature and humidity measuring device Z of the present embodiment is similar to the temperature and humidity measuring device Z of the above-mentioned embodiment, and thus configurations or actions of the same components will not be repeated herein. The present embodiment is different from the first embodiment in the following manner. In the present embodiment, the container component D1 includes the main body member D10. The main body member D10 has the top portion D100, the bottom portion D101, and the side portions D102. The top portion D100 has the first opening D100a, and the bottom portion D101 is disposed opposite to the top portion D100. The side portions D102 are connected to the top portion D100 and the bottom portion D101 to define the accommodating space DS, and one of the side portions D102 has the second opening D102a. The position limiting component D2 can include a base member D23 which can be connected to the bottom portion D101, and the at least one positioning member D22 which can be connected to the base member D23. One side of the position limiting component D2 is recessed to form the at least one gripping portion D22a, and the at least one gripping portion D22a has the notch D22b that corresponds to the top portion D100.

For example, as shown in FIG. 9 and FIG. 10, the position limiting component D2 can be disposed at the bottom of the container component D1. Specifically, the base member D23 of the position limiting component D2 is disposed on the bottom portion D101 and soaked in the liquid L. The quantity of the position limiting component D2 disposed on top of the base member D23 is at least one. In the present embodiment, the quantity of the position limiting component D2 is exemplified as being two, but is not limited thereto. Therefore, after the user inserts the second measuring component 12 of the measuring module 1 into the wet bulb supply module D, the second measuring component 12 can be gripped by the position limiting component D2 on the base member D23 and positioned in the container component D1, so as to prevent displacement of the second measuring component 12.

However, the aforementioned examples describe only one of the embodiments of the present disclosure, and the present disclosure is not intended to be limited thereto.

### Beneficial Effects of the Embodiments

In conclusion, in the temperature and humidity measuring device Z provided by the present disclosure, by virtue of “the measuring module 1 having a first measuring portion 11a and a second measuring portion 12a, the first measuring portion 11a being configured to measuring a temperature of a current environment under a first state for acquiring first temperature information, and the second measuring portion 12a being configured to measure the temperature of the current environment under a second state for acquiring second temperature information,” “the wet bulb supply module D including a container component D1, a position limiting component D2 and a wet bulb component D3, the container component D1 having a first opening D100a, a second opening D102a, and an accommodating space DS, the first opening D100a being formed on a top surface of the container component D1, the second opening D102a being formed on a side surface of the container component D1, the accommodating space DS being in spatial communication with the first opening D100a and the second opening D102a, and the accommodating space DS being configured to accommodate a liquid L,” “the position limiting component D2 being disposed in the accommodating space DS and having at least one gripping portion that corresponds to the second opening D102a,” “the wet bulb component D3 being disposed in the accommodating space DS and corresponding to the first opening D100a, and the wet bulb component D3 being configured to contact the liquid L,” and “the wet bulb supply module D being configured to allow the measuring module 1 to extend into the accommodating space DS through the second opening D102a, being configured to use the at least one gripping portion D22a to grip the measuring module 1, and being configured to cover the second measuring portion 12a with the wet bulb component D3, so that the second measuring portion 12a being in the second state,” the convenience in measuring relative humidity can be improved.

Furthermore, in the wet bulb supply module D provided by the present disclosure, by virtue of “the container component D1 having a first opening D100a, a second opening D102a, and an accommodating space DS, the first opening being D100a formed on a top surface of the container component D1, the second opening D102a being formed on a side surface of the container component D1, the accommodating space DS being in spatial communication with the first opening D100a and the second opening D102a, and the accommodating space DS being configured to accommodate a liquid L,” “the position limiting component D2 being disposed in the accommodating space DS and having at least one gripping portion D22a that corresponds to the second opening D102a,” “the wet bulb component D3 being disposed in the accommodating space and corresponding to the first opening D100a, and the wet bulb component D3 being configured to configured to contact the liquid L,” and “the wet bulb supply module D being configured to allow a measuring module 1 to extend into the accommodating space DS through the second opening D102a, and being configured to use the at least one gripping portion D22a to grip the measuring module 1, and being configured to cover the measuring module 1 with the wet bulb component D3,” the convenience in measuring relative humidity can be improved.

More specifically, the temperature and humidity measuring device Z provided by the present disclosure can have the function of measuring relative humidity by using a conventional probe temperature measuring device with the wet bulb supply module D and without using a commercially available humidity sensor. Based on the technical means described above, the temperature and humidity measuring device Z and the wet bulb supply module D of the present disclosure allow an operator to place the second measuring component 12 of the measuring module 1 anytime and anywhere through implementation and the structural design of the wet bulb supply module D, and the second measuring component 12 can be used to sense parameters (such as humidity, relative humidity, or a dew point) of the current environment. Moreover, the temperature and humidity measuring device Z of the present disclosure can automatically calculate the relative humidity, the dew point, or the data thereof by using the first equation to the eighth equation and the relevant parameters stored in the processing component 13 together with the data acquired by the first measuring portion 11a and the second measuring portion 12a. In this way, not only can the user conveniently carry the temperature and humidity measuring device Z and the wet bulb supply module D of the present disclosure, but the convenience in use thereof can also be improved.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A temperature and humidity measuring device, comprising:
a measuring module, wherein the measuring module has a first measuring portion and a second measuring portion, the first measuring portion is configured to measure a temperature of a current environment under a first state for acquiring first temperature information, and the second measuring portion is configured to measure the temperature of the current environment under a second state for acquiring second temperature information; and
a wet bulb supply module, wherein the wet bulb supply module includes:
a container component, wherein the container component has a first opening, a second opening, and an accommodating space, the first opening is formed on a top surface of the container component, the second opening is formed on a side surface of the container component, the accommodating space is in spatial communication with the first opening and the second opening, and the accommodating space is configured to accommodate a liquid;
a position limiting component disposed in the accommodating space, wherein the position limiting component has at least one gripping portion that corresponds to the second opening; and
a wet bulb component disposed in the accommodating space and corresponding to the first opening, wherein the wet bulb component is configured to contact the liquid;
wherein the wet bulb supply module is configured to allow the measuring module to extend into the accommodating space through the second opening, is configured to use the at least one gripping portion to grip the measuring module, and is configured to cover the second measuring portion with the wet bulb component, so that the second measuring portion is in the second state.

2. The temperature and humidity measuring device according to claim 1,
wherein the measuring module includes:
a body component;
a first measuring component disposed in the body component, wherein one end of the first measuring component has the first measuring portion;
a second measuring component connected to the body component, wherein one end of the second measuring component has the second measuring portion; and
a processing component disposed in the body component, wherein the processing component is connected to the first measuring component and the second measuring component; wherein the processing component is configured to receive the first temperature information and the second temperature information, and is configured to acquire relative humidity information according to a first equation;
wherein the first equation is:
$$RH = \frac{{e}_{w} - N * ( 1 + 0.00115 * {T}_{w} ) * ( {T}_{d} - {T}_{w} )}{{e}_{d}} * 100 ;$$
wherein, in the first equation, RH is the relative humidity information, e_{d} is a dry vapor pressure parameter, e_{w} is a wet vapor pressure parameter, N is 0.6687451584, T_{d} is the first temperature information, and T_{w} is the second temperature information;
wherein the processing component is configured to acquire the dry vapor pressure parameter according to the first temperature information and a second equation, and is configured to acquire the dry vapor pressure parameter according to the second temperature information and a third equation;
wherein the second equation is:
$${e}_{d} = 6.1 \; 12 * {e}^{( \frac{17.502 * {T}_{d}}{240.97 + {T}_{d}} )} ;$$
wherein the third equation is:
$${e}_{w} = 6.1 \; 12 * {e}^{( \frac{17.502 * {T}_{w}}{240.97 + {T}_{w}} )} ;$$
wherein, in the second equation and the third equation, e is taken as 2.71828182845904.

3. The temperature and humidity measuring device according to claim 2, wherein the processing component is configured to acquire a first algebra parameter according to the relative humidity information and a fourth equation, the first algebra parameter is L, and the fourth equation is: L=ln (RH/100);
wherein the processing component is configured to acquire a second algebra parameter according to the first temperature information and a fifth equation, the second algebra parameter is M, and the fifth equation is: M=17.27*T_{d};
wherein the processing component is configured to acquire a third algebra parameter according to the first temperature information and a sixth equation, the third algebra parameter is N, and the sixth equation is: N=237.3+T_{d};
wherein the processing component is configured to acquire a fourth algebra parameter according to the first algebra parameter, the second algebra parameter, the third algebra parameter, and a seventh equation, the fourth algebra parameter is B, and the seventh equation is: B=(L+ (M/N))/17.27;
wherein the processing component is configured to acquire dew point information according to the fourth algebra parameter and an eighth equation, the dew point information is T_{dew}, and the eighth equation is: T_{dew}=(237.3*B)/(1−B).

4. The temperature and humidity measuring device according to claim 1, wherein the container component includes a main body member, the main body member has a top portion, a bottom portion, and a plurality of side portions, the top portion has the first opening, the bottom portion is disposed opposite to the top portion, the side portions are connected to the top portion and the bottom portion to define the accommodating space, and one of the side portions has the second opening;
wherein the position limiting component includes a first fastener, a second fastener, and at least one positioning member, and the first fastener and the second fastener are connected to the top portion or one or more of the side portions; wherein the at least one positioning member is connected to the first fastener and the second fastener, and is disposed between the first fastener and the second fastener; wherein one side of the at least one position limiting member is recessed to form the at least one gripping portion, and the at least one gripping portion has a notch that corresponds to the top portion or the bottom portion.

5. The temperature and humidity measuring device according to claim 4, wherein the container component further includes a first cover body and a second cover body, the first cover body is movably connected to the main body member and opens or covers the first opening, and the second cover is movably connected to the main body member and opens or covers the second opening.

6. The temperature and humidity measuring device according to claim 1, wherein the container component includes a main body member, the main body member has a top portion, a bottom portion, and a plurality of side portions, the top portion has the first opening, the bottom portion is disposed opposite to the top portion, the side portions are connected to the top portion and the bottom portion to define the accommodating space, and one of the side portions has the second opening;
wherein the position limiting component includes a base member and at least one positioning member, the base member is connected to the bottom portion, and the at least one positioning member is connected to the base member; wherein one side of the at least one position limiting member is recessed to form the at least one gripping portion, and the at least one gripping portion has a notch that corresponds to the top portion.

7. A wet bulb supply module, comprising:
a container component, wherein the container component has a first opening, a second opening, and an accommodating space, the first opening is formed on a top surface of the container component, the second opening is formed on a side surface of the container component, the accommodating space is in spatial communication with the first opening and the second opening, and the accommodating space is configured to accommodate a liquid;
a position limiting component disposed in the accommodating space, wherein the position limiting component has at least one gripping portion that corresponds to the second opening; and
a wet bulb component disposed in the accommodating space and corresponding to the first opening, wherein the wet bulb component is configured to contact the liquid;
wherein the wet bulb supply module is configured to allow a measuring module to extend into the accommodating space through the second opening, is configured to use the at least one gripping portion to grip the measuring module, and is configured to cover the measuring module with the wet bulb component.

8. The wet bulb supply module according to claim 7, wherein the container component includes a main body member, the main body member has a top portion, a bottom portion, and a plurality of side portions, the top portion has the first opening, the bottom portion is disposed opposite to the top portion, the side portions are connected to the top portion and the bottom portion to define the accommodating space, and one of the side portions has the second opening;
wherein the position limiting component includes a first fastener, a second fastener, and at least one positioning member, and the first fastener and the second fastener are connected to the top portion or one or more of the side portions; wherein the at least one positioning member is connected to the first fastener and the second fastener, and is disposed between the first fastener and the second fastener; wherein one side of the at least one positioning member is recessed to form the at least one gripping portion, and the at least one gripping portion has a notch that corresponds to the top portion or the bottom portion.

9. The wet bulb supply module according to claim 8, wherein the container component further includes a first cover body and a second cover body, the first cover body is movably connected to the main body member and is configured to open or cover the first opening, and the second cover body is movably connected to the main body member and is configured to open or cover the second opening.

10. The wet bulb supply module according to claim 7, wherein the container component includes a main body member, the main body member has a top portion, a bottom portion, and a plurality of side portions, the top portion has the first opening, the bottom portion is disposed opposite to the top portion, the side portions are connected to the top portion and the bottom portion to define the accommodating space, and one of the side portions has the second opening;
wherein the position limiting component includes a base member and at least one positioning member, the base member is connected to the bottom portion, and the at least one positioning member is connected to the base member; wherein one side of the at least one positioning member is recessed to form the at least one gripping portion, and the at least one gripping portion has a notch that corresponds to the top portion.
